(19) United States
(12) Patent Application Publication
(10) Pub. No.: US 2024/0157829 A1
(43) Pub. Date: May 16, 2024

(54) CHARGING SYSTEM

(71) Applicant: TOYOTA JIDOSHA KABUSHIKI KAISHA, Toyota-shi (JP)

(72) Inventor: Shota TSUKAMOTO, Mishima-shi (JP)

(73) Assignee: TOYOTA JIDOSHA KABUSHIKI KAISHA, Toyota-shi (JP)

(21) Appl. No.: 18/466,295

(22) Filed: Sep. 13, 2023

(30) Foreign Application Priority Data
Nov. 11, 2022 (JP) 2022-180813

(51) Int. Cl. B60L 53/35; B60L 53/16; B60L 58/20; H02J 7/00

(52) U.S. Cl. CPC B60L 53/35; B60L 53/16; B60L 58/20; H02J 7/0042

(57) ABSTRACT

A charging system that charges a traveling battery of a vehicle by supplying power to the traveling battery from a charging device that inserts and removes a connector into and from an inlet of the vehicle, includes: a relay that electrically connects and disconnects an auxiliary battery of the vehicle and the charging device in a state in which the inlet and the connector are connected. Further, in a case where a power to be supplied to the charging device is lost, the charging system operates in a manner that the relay is turned on so that the auxiliary battery and the charging device are electrically connected, power is supplied from the auxiliary battery to the charging device, and the charging device automatically removes the connector from the inlet.

### CROSS-REFERENCE TO RELATED APPLICATION(S)

The present application claims priority to and incorporates by reference the entire contents of Japanese Patent Application No. 2022-180813 filed in Japan on Nov. 11, 2022.

### BACKGROUND

The present disclosure relates to a charging system. Japanese Laid-open Patent Publication No. 2010-239850 discloses a technology of maintaining communication by supplying power from a vehicle to a control unit of a charging stand in order to end a charging sequence without any problem in a case where a power failure is generated during charging.

### SUMMARY

There is a need for providing a charging system capable of automatically releasing connection between an inlet of a vehicle and a connector of a charging device in a case where power to be supplied to the charging device is lost.

According to an embodiment, a charging system that charges a traveling battery of a vehicle by supplying power to the traveling battery from a charging device that inserts and removes a connector into and from an inlet of the vehicle, includes: a relay that electrically connects and disconnects an auxiliary battery of the vehicle and the charging device in a state in which the inlet and the connector are connected. Further, in a case where a power to be supplied to the charging device is lost, the charging system operates in a manner that the relay is turned on so that the auxiliary battery and the charging device are electrically connected, power is supplied from the auxiliary battery to the charging device, and the charging device automatically removes the connector from the inlet.

### BRIEF DESCRIPTION OF THE DRAWINGS

FIG. 1 is a view illustrating a schematic configuration of a charging system according to an embodiment;

FIG. 2 is a view illustrating a schematic configuration of an automatic charging device in a state in which a relay is in an OFF state;

FIG. 3 is a view illustrating a schematic configuration of the automatic charging device in a state in which the relay is in an ON state; and

FIG. 4 is a flowchart illustrating an example of control performed in the charging system.

### DETAILED DESCRIPTION

In the related art, in a charging system that performs charging by supplying power to a traveling battery of a vehicle from an automatic charging device that inserts and removes a connector into and from an inlet of the vehicle, there is a possibility that a power failure is generated in a state in which the inlet and the connector are connected. As described above, in a case where the power failure is generated and a power supply that supplies power to the automatic charging device is lost, the automatic charging device cannot release the connection between the inlet and the connector. Thus, the vehicle cannot be disconnected from the automatic charging device.

Hereinafter, an embodiment of a charging system according to the present disclosure will be described. Note that the present disclosure is not limited to the present embodiment.

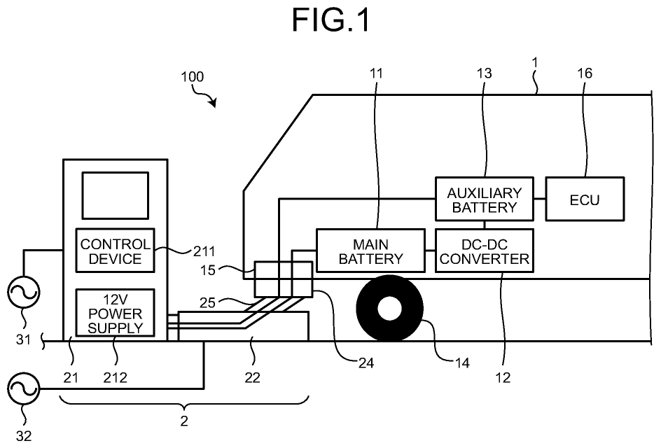

FIG. 1 is a view illustrating a schematic configuration of a charging system 100 according to the embodiment. The charging system 100 according to the embodiment includes a vehicle 1 and an automatic charging device 2.

The vehicle 1 is parked in a parking space provided on a side of the automatic charging device 2. The vehicle 1 is, for example, an electric vehicle having at least a traveling motor as a power source for traveling. The vehicle 1 includes a main battery 11, a DC-DC converter 12, an auxiliary battery 13, a drive wheels 14, an inlet 15, an electronic control unit (ECU) 16, and the like. The main battery 11 stores, for example, power to be supplied to a traveling motor, an inverter, and the like that drive the drive wheels 14 when the vehicle 1 travels. The DC-DC converter 12 can transform the power from the main battery 11 and supply the power to the auxiliary battery 13. The auxiliary battery 13 stores, for example, power to be supplied to the ECU 16 and the like. The main battery 11 and the auxiliary battery 13 are configured to be electrically connectable to charging equipment 21, which is an external power supply, via the inlet 15. The ECU 16 can perform various kinds of control in the vehicle 1. For example, the ECU 16 is configured to be able to communicate with a control device 211 of the charging equipment 21 in a wireless or wired manner, and can control charging of the main battery 11 by performing communication for charging with the control device 211 of the charging equipment 21.

The automatic charging device 2 includes the charging equipment 21 and an arm device 22. Power is supplied from a system power supply 31 to the charging equipment 21. The charging equipment 21 includes the control device 211 and a 12 V power supply 212. The control device 211 can perform charging control by performing communication for charging with the ECU 16 of the vehicle 1.

Power is supplied from the system power supply 31 to the arm device 22. The arm device 22 includes a charging arm 25 having a connector 24. The arm device 22 drives the charging arm 25 and automatically performs insertion and removal of the connector 24 into and from the inlet 15 of the vehicle 1 located in the parking space provided on the side of the automatic charging device 2.

In the automatic charging device 2, automatic charging in which the control device 211 of the charging equipment 21 controls the arm device 22, the arm device 22 automatically inserts and removes the connector 24 into and from the inlet 15 of the vehicle 1, and charging of the main battery 11 of the vehicle 1 is performed can be executed. In addition, the 12 V power supply 212 of the charging equipment 21 is electrically connected to the auxiliary battery 13 of the vehicle 1 via the arm device 22 in a state in which the inlet 15 of the vehicle 1 and the connector 24 of the arm device 22 are connected.

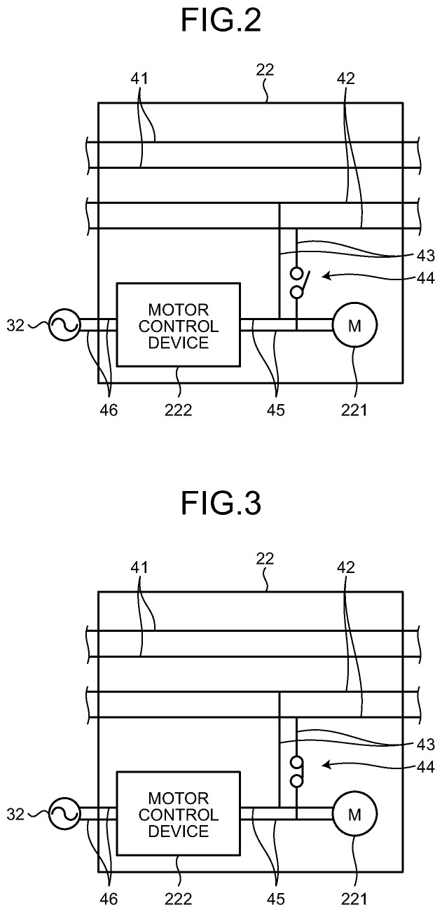

FIG. 2 is a view illustrating a schematic configuration of the arm device 22 when a relay 44 is in an OFF state. FIG. 3 is a view illustrating a schematic configuration of the arm device 22 when the relay 44 is in an ON state.

The arm device 22 includes a high-voltage power line 41, an 12 V power line 42, a power line 43, the relay 44, a power line 45, a power line 46, a drive motor 221, a motor control device 222, and the like. The high-voltage power line 41 is a power line that conducts high-voltage power supplied from the charging equipment 21 to the main battery 11. The 12 V power line 42 is a power line that electrically connects the auxiliary battery 13 of the vehicle 1 and the 12 V power supply 212 of the charging equipment 21. The 12 V power line 42 is electrically connected to the power line 45, which electrically connects the drive motor 221 and the motor control device 222, via the power line 43 in which the relay 44 is provided. When power is supplied from a system power supply 32 to the arm device 22, the relay 44 is brought into the OFF state, in which the electrical connection between the 12 V power line 42 and the power line 45 is cut off, by a relay opening/closing mechanism as illustrated in FIG. 2. On the other hand, when the power is not supplied from the system power supply 32 to the arm device 22, the relay 44 is brought into the ON state, in which the 12 V power line 42 and the power line 45 are electrically connected, by the relay opening/closing mechanism as illustrated in FIG. 3. The drive motor 221 is a driving source that generates a driving force for driving the charging arm 25 in such a manner that the connector 24 is connected to or disconnected from an inlet 18 of the vehicle 1. The motor control device 222 can control driving of the drive motor 221 in such a manner that the connector 24 is connected to or disconnected from the inlet 18 of the vehicle 1. Power for driving the drive motor 221 is supplied from the system power supply 32 to the motor control device 222 via the power line 46.

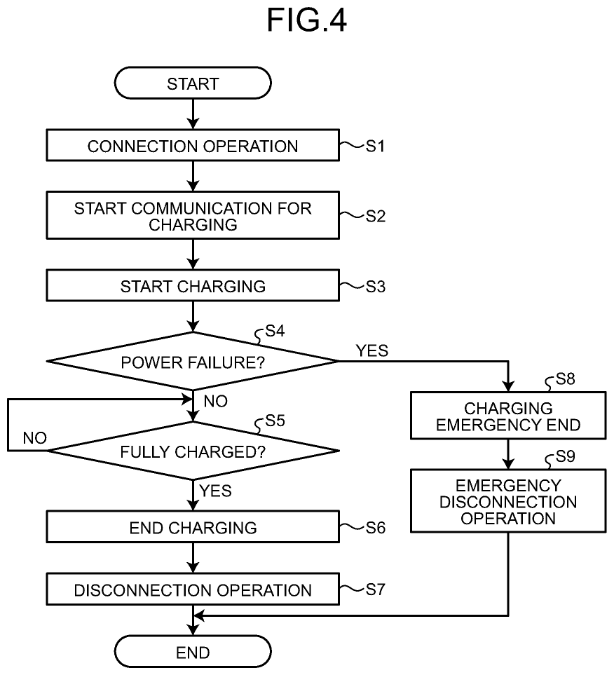

FIG. 4 is a flowchart illustrating an example of control performed in the charging system 100.

First, in the charging system 100, when the charging equipment 21 receives a charging start instruction from a user, the motor control device 222 of the arm device 22 drives the charging arm 25 with the drive motor 221, and executes connection operation of connecting the connector 24 to the inlet 15 (Step S1). Then, the control device 211 of the charging equipment 21 starts communication for charging with the ECU 16 of the vehicle 1 (Step S2). Then, the control device 211 of the charging equipment 21 supplies power from the charging equipment 21 to the main battery 11 of the vehicle 1 via the arm device 22, and starts charging of the main battery 11 (Step S3).

Then, the ECU 16 of the vehicle 1 determines whether a power failure is generated in the system power supplies 31 and 32 that supply power to the automatic charging device 2 (Step S4). In a case of determining that the power supply from the charging equipment 21 to the main battery 11 is continued and the power failure is not generated (No in Step S4), the ECU 16 of the vehicle 1 determines whether the main battery 11 is fully charged (Step S5). In a case of determining that the main battery 11 is not fully charged (No in Step S5), the ECU 16 of the vehicle 1 repeats the processing in Step S5 until the main battery 11 is fully charged. In a case of determining that the main battery 11 is fully charged (Yes in Step S5), the ECU 16 of the vehicle 1 communicates with the control device 211 of the charging equipment 21, stops the power supply from the charging equipment 21 to the main battery 11, and ends the charging (Step S6). Then, the motor control device 222 of the arm device 22 drives the charging arm 25 by the drive motor 221 and executes disconnection operation of disconnecting the connector 24 from the inlet 15 of the vehicle 1 (Step S7). Subsequently, the charging system 100 ends the control of the example.

On the other hand, in a case of determining in Step S4 that the power supply from the charging equipment 21 to the main battery 11 is interrupted and the power failure is generated (Yes in Step S4), the ECU 16 of the vehicle 1 executes a charging emergency end of ending the charging of the main battery 11 (Step S8). Then, the ECU 16 of the vehicle 1 supplies power from the auxiliary battery 13 of the vehicle 1 to the drive motor 221 of the arm device 22, and executes the emergency disconnection operation in which the connection between the inlet 15 and the connector 24 is automatically released (Step S9). Subsequently, the charging system 100 ends the control of the example.

In the charging system 100 according to the embodiment, in a case where the system power supplies 31 and 32 are lost due to the power failure or the like, the power is supplied from the auxiliary battery 13 of the vehicle 1 to the drive motor 221 of the arm device 22 via a connection portion between the inlet 15 and the connector 24. As a result, in the charging system 100 according to the embodiment, it is possible to drive the charging arm 25 by the drive motor 221 and to remove the connector 24 from the inlet 15. Thus, in the charging system 100 according to the embodiment, even when the system power supplies 31 and 32 are lost due to the power failure or the like, it is possible to perform the emergency disconnection operation in which the connection between the inlet 15 and the connector 24 is automatically released. Thus, it is possible to disconnect the vehicle 1 from the automatic charging device 2.

The charging system according to the present disclosure has an effect that it is possible to supply power from the auxiliary battery of the vehicle to the charging device and to release the connection between the inlet and the connector in a case where the power supply that supplies power to the charging device is lost.

In the charging system according to the present disclosure, in a case where the power supply that supplies power to the charging device is lost, the power can be supplied from an auxiliary battery of the vehicle to the charging device, and the connection between the inlet and the connector can be automatically released.

As a result, an arm device can automatically perform insertion and removal of the connector into and from the inlet and execute automatic charging of charging a traveling battery of the vehicle.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A charging system that charges a traveling battery of a vehicle by supplying power to the traveling battery from a charging device that inserts and removes a connector into and from an inlet of the vehicle, the charging system comprising:
a relay that electrically connects and disconnects an auxiliary battery of the vehicle and the charging device in a state in which the inlet and the connector are connected, wherein
in a case where a power to be supplied to the charging device is lost, the charging system is configured in a manner that the relay is turned on so that the auxiliary battery and the charging device are electrically connected, power is supplied from the auxiliary battery to the charging device, and the charging device automatically removes the connector from the inlet.

2. The charging system according to claim 1, wherein the charging device includes an arm device that automatically performs insertion and removal of the connector into and from the inlet.
